(19) United States
(12) Patent Application Publication
(10) Pub. No.: US 2026/0109118 A1
(43) Pub. Date: Apr. 23, 2026

(54) METHOD AND APPARATUS FOR APPLYING A DOSE OF MATERIAL

(71) Applicant: SACMI COOPERATIVA MECCANICI IMOLA SOCIETA’ COOPERATIVA, Imola (BO) (IT)

(72) Inventors: Fabrizio VILLA, Imola (BO) (IT); Carlo VENTURI, Faenza (RA) (IT); Marco MINGHETTI, Sant'Agata sul Santerno (BO) (IT); Roberto CIPOLLINI, Forlì (FC) (IT)

(21) Appl. No.: 19/117,264

(22) PCT Filed: Nov. 20, 2023
(86) PCT No.: PCT/IB2023/061670

§ 371 Date: Mar. 31, 2025

(30) Foreign Application Priority Data
Dec. 27, 2022 (IT) 102022000026898

(51) Int. Cl. B29C 70/80; B29C 43/18; B29C 43/34; B29L 31/56

(52) U.S. Cl. CPC B29C 70/80; B29C 43/18; B29C 43/34; B29C 2043/3433; B29L 2031/565

(57) ABSTRACT

A method and an apparatus for applying a dose of sealing material to a closing cap of a container to form a gasket are disclosed, in which an annular dose is separated from a flow of plasticized material and is deposited on a base of the cap; the plasticized material is fed through a channel until it arrives at a material outlet extending along a circumferential direction; the annular dose comprises at least one differentiated portion, whereby a radial section in the differentiated portion of the annular dose is different from a radial section in another portion of the annular dose, where “radial” is understood to refer to an axis about which the annular dose extends in a circumferential direction; the presence of a differentiated portion decreases the risk of forming an air pocket between the sealing material and the caps.

### BACKGROUND OF THE INVENTION

The invention relates to a method and an apparatus for applying a dose of material, for example sealing material, in particular by separating a dose of material from a continuous flow of plasticized material by extrusion and applying the separated dose onto a surface of an object, for example inside a cap for closing a container.

Specifically but not exclusively, the invention can be used to apply an annular dose of material (in particular, sealing material) to a surface, for example to form an annular gasket on an object, for example inside a cap (made of metal or plastics) for closing a container, or for applying an annular dose of material to a flat element (for example a disk), in particular made of metal or plastics, which can then be inserted, with a sealing function, into a more complex device, or for applying an annular dose of material (in particular with a sealing function) to a cardboard element intended, for example, to form a container or a portion of a container, or directly to a container, for example made of plastics or metal, or for inserting an annular dose of material directly into a mould to obtain an object therefrom (for example an annular object), in particular with a closing function (for example a plug consisting of a wall made of plastics and of a central metal disk provided with a gasket obtained from the annular dose) or also with another function different from the closing function.

Each of the patent publications JP H06-312762 A, US 2012/0171381 A1, US 2017/0239848 Al and US 2020/0376724 A1 shows an application method as in the preamble to claim 1, in which the radial section of the annular dose that is separated is constant over the entire circumferential extent of the dose.

One of the problems of the prior art is applying an annular dose of material (in particular, sealing material that is suitable for forming a gasket) to an object, in particular to a base of an object (for example, a cap for closing containers) and to the inside of an annular wall of the object, without the formation of air pockets between the material of the annular dose and the object, in particular in the transition zone between the base and the annular wall of the object.

### SUMMARY OF THE INVENTION

One object of the invention is to propose a method and/or an apparatus that is able to overcome the aforesaid problem of the prior art.

One object of the invention is to provide an application method and/or an application apparatus that are alternatives to those of the prior art.

One advantage is to provide an apparatus that is constructionally simple and cheap to apply an annular dose of material to a surface of an object, in particular to form a gasket in a closing cap.

One advantage is to apply an annular dose of sealing material to form a gasket on a base of a cap for closing containers and inside an annular wall of the cap, without leaving air pockets in the transition zone between the base and the annular wall of the cap.

Such objects and advantages, and still others, are achieved by a method and/or an apparatus according to one or more of the claims set out below.

In one embodiment, an application method, in particular for applying an annular dose of sealing material inside a closing cap of a container to form a gasket, comprises the step of separating an annular dose from a flow of plasticized material and of depositing the annular dose on an object, in which the plasticized material is fed through a channel until it arrives at a material outlet that extends along a circumferential direction, and in which the annular dose that is separated comprises at least one differentiated portion, where a differentiated portion is understood to be a radial section in the differentiated portion that is different from a radial section in another portion of the annular dose, where “radial” is understood to refer to an axis about which the annular dose extends in a circumferential direction.

The annular dose that is separated may comprise, in particular, a plurality of continuous portions or segments of material (for example three, or four, or five, or six, continuous portions or segments of material) each of which extends along an arc of circumference (for example portions or segments of material that are each in the shape of a circular crown arc) interspersed with the same number of differentiated portions each of which comprises a cavity free of material, which cavity is arranged in a space comprised between two continuous portions or segments of material. Each continuous portion or segment of material may be shaped as an arc with a circular sector with an angular extent greater than 30°, or greater than 45°, or greater than 60°. The continuous portions or segments of material may have a constant radial section over the entire length or circumferential extent thereof.

Each cavity of a respective differentiated portion may occupy all the space comprised between two continuous portions or segments of material, so that between the two continuous portions or segments of material an empty space is present that is completely free of material, or between the two continuous portions or segments of material it is possible for there to be a bridge or rib of material with a radial section that is thinner than a radial section of the two continuous portions or segments of material. The bridge or rib of material may be arranged, in particular, to connect together the two continuous portions or segments of material. In this case, a radial section of a differentiated portion is less than (with at least one dimension that is less than 0.1 mm) a radial section of a continuous portion or segment of material adjacent to the differentiated portion.

It is possible to provide other embodiments in which a radial section of a differentiated portion is greater (with at least one dimension that more than 0.1 mm greater) than a radial section of a continuous portion or segment of material adjacent to the differentiated portion. A differentiated portion may comprise, in particular, a protruding appendage that increases the radial section thereof.

It has been observed that the presence of a differentiated portion in the annular dose significantly decreases the risk of an air pocket being formed between the annular dose and the object on which the annular dose has been deposited, especially when the annular dose is pressed on the object, for example to form a gasket.

In particular, when the annular dose of material is deposited on a base of an object and inside an annular wall of the object, an effect of evacuating the air has been ascertained and thus a decrease in the risk of formation of an air pocket in the transition zone between the base and the annular wall of the object, especially when the annular dose deposited on the object is pressed against the object (for example to form an annular gasket inside a cap for closing containers).

It has been found that a certain efficacy in evacuating the air, which is such as to reduce the risk of air pockets, may be detectable already with differentiated portions of dose each of which has a radial section having at least one dimension (for example, height or width) that is at least 0.1 millimeter different from (less or possibly greater than) a radial section in another portion of the annular dose.

### BRIEF DESCRIPTION OF DRAWINGS

The invention can be better understood and implemented with reference to the enclosed drawings that illustrate some non-limiting embodiments, in which:

FIG. 1 is an exploded view of a first embodiment of an application apparatus according to the first embodiment;

FIG. 2 is a perspective view, sectioned with two section planes that are orthogonal to one another, of the application apparatus of FIG. 1;

FIG. 3 is a partially sectioned view in vertical elevation of the application apparatus of FIG. 1;

FIG. 4 is section IV-IV of FIG. 3;

FIG. 5 shows in a partially sectioned view in vertical elevation, two operating steps of the application apparatus of FIG. 1, wherein, on the left, the annular dose is in a forming step exiting the extruder, and, on the right, the annular dose is in a cutting and separating step;

FIG. 6 shows, in a totally sectioned vertical elevation, the two operating steps of the application apparatus of FIG. 5;

FIG. 7 is a partial perspective view of a second embodiment of an application apparatus according to the first embodiment, with some parts removed to better highlight others;

FIG. 8 is a view, from another perspective, of the application apparatus of FIG. 7, with some parts removed to better highlight others;

FIG. 9 is a view, from yet another perspective, of the application apparatus of FIG. 7, where the separated annular dose is highlighted better;

FIG. 10 is a partial perspective view, sectioned with two section planes that are orthogonal to one another, of a third embodiment of an application apparatus according to the present invention;

FIG. 11 is a view, from another perspective, of the application apparatus of FIG. 10, where the separated annular dose is highlighted better;

FIG. 12 is an exploded view of a fourth embodiment of an application apparatus according to this invention;

FIG. 13 is an enlarged detail of FIG. 12;

FIG. 14 is a section in vertical elevation of a fifth embodiment of an application apparatus according to the first embodiment, in an operating step in which the annular dose has been separated;

FIG. 15 is an enlarged detail of FIG. 14;

FIG. 16 shows a part of the section of FIG. 14 in an operating step in which the annular dose has not yet been separated;

FIG. 17 is an enlarged detail of FIG. 16;

FIG. 18 is an exploded partial view in a sixth embodiment of an application apparatus according to the present invention;

FIG. 19 is a section, in vertical elevation, of a detail of the application apparatus of FIG. 18 in an operating step in which the annular dose has not yet been separated;

FIG. 20 is section of FIG. 19 in an operating step in which the annular dose has been separated;

FIG. 21 is an exploded view in vertical elevation of a seventh embodiment of an application apparatus according to this invention;

FIG. 22 is an enlarged detail of FIG. 21;

FIG. 23 is a section, in vertical elevation, of a detail of the application apparatus of FIG. 21 in an operating step in which the annular dose has not yet been separated;

FIG. 24 is section of FIG. 23 in an operating step in which the annular dose has been separated;

FIG. 25 is a partial perspective view of an eighth embodiment of an application apparatus according to present invention;

FIG. 26 is a section, in vertical elevation, of a detail of the application apparatus of FIG. 25 in an operating step in which the annular dose has not yet been separated;

FIG. 27 is section of FIG. 26 in an operating step in which the annular dose has been separated;

FIG. 28 is a perspective view that shows an annular dose made with application apparatus according to the present invention;

FIG. 29 is a section or a first cap for closing containers with an annular gasket made by moulding an annular dose applied with an application apparatus according to the present invention;

FIG. 30 shows an enlarged detail of FIG. 29;

FIG. 31 is a section of a second cap for closing containers with an annular gasket made by moulding an annular dose applied with an application apparatus according to the present invention;

FIG. 32 shows an enlarged detail of FIG. 31.

### DETAILED DESCRIPTION

In the aforesaid figures, analogous elements of different embodiments have been indicated by the same numbers.

1 indicates overall an application apparatus, usable in particular for applying a dose D of sealing material for forming an annular gasket on an object P. The applying may occur, in particular, by separating an annular dose D of material from a continuous flow of plasticized material (for example by extrusion) and applying the annular dose D to a surface of an object P, for example inside a cap for closing a container.

The annular dose D may be applied inside a closing cap (for example a cap made of metal or plastics). In other embodiments the annular dose may be applied to a flat element (for example a disk), in particular made of metal or plastics, into which the flat element may then be inserted, with a sealing function, in a more complex device.

The annular dose could also be applied (in particular with a sealing function) to a cardboard element intended, for example, to form a container or a portion of a container.

The annular dose could be applied directly to a container, for example made of plastics or metal. In still other embodiments, the annular dose could be inserted directly into a mould to obtain an object thereof (for example an annular object), in particular with closing functions (for example a plug consisting of a wall made of plastics and of a central metal disk provided with a gasket obtained from the annular dose) or also with different functions from the closing functions.

The application apparatus 1 may belong, in particular, to an application machine (not illustrated) of rotating type comprising a carousel, that rotatingly supports a plurality of application apparatuses (for example the same as the application apparatus 1) arranged angularly spaced apart from each other, and an extruder (for example of screw type), that feeds the plasticized material to the application apparatuses. It is thus possible for the application apparatus 1 to belong to an application machine of linear rather than rotating type.

The application apparatus 1 may comprise, or may be operationally associated (for example connected in a processing line) with compression forming means for forming the annular dose D after the dose has been deposited on the object P. Such compression forming means (which is not illustrated) may be arranged, in particular, on a carousel arranged downstream of the application apparatus 1 that forms and applies the annular doses D.

The application apparatus 1 comprises a feeder 2 of molten or plasticized material. The feeder 2 may be connected, in particular, to the extruder that may be configured to feed plasticized sealing material suitable for forming a gasket.

Inside the feeder 2, at least one channel 3 may be received to feed the material as far as at least one material outlet 4 extending along a circumferential direction about an axis of the feeder 2 (for example a vertical axis, considering a position of use of the application apparatus 1).

The channel 3 may comprise, in particular, an annular portion for the passage of the plasticized material that may end with the material outlet 4. The annular portion of the channel 3 may communicate, for example in a derivation relation, with a channel portion located upstream, for example a portion of channel with a straight cross section of circular shape or with another solid shape.

The material outlet 4 may be so configured that the outlet direction of the annular flow of extruded plasticized material has, at each outlet point, at least one normal component that is radial in relation to the (vertical) axis of the feeder 2, in particular has at least one horizontal radial component.

The feeder 2 may comprise, in particular, valve means for regulating the flow of the plasticized material. The feeder 2 may comprise, in particular, thermal conditioning means (for example one or more resistances) for heating one or more portions in contact with the plasticized material.

The feeder 2 may comprise, in particular, an internal portion 5 and an external portion 6 which surrounds at least partially the internal portion 5. The external portion 6 may be, in particular, bush-shaped. The channel 3 may be, in particular, defined between the internal portion 5 and the external portion 6.

The application apparatus 1 comprises a separator 7 which surrounds the feeder 2 and which is configured to separate an annular dose D of material from the material outlet 4. The separator 7 and the feeder 2 are movable coaxially (in particular along the axis of the feeder) in relation to one another. In the specific embodiments illustrated here, the separator 7 is movable with a (vertical) linear motion by driving means, for example driving means of known type.

The separator 7 may comprise, in particular, an annular cutting element which surrounds the feeder 2 and which in a step of separating the annular dose D, passes in front of the material outlet 4 to cut the dose.

The separator 7 may be movable with the possibility of adopting at least one pre-cutting position, in which the separator 7 enables the plasticized material to exit the material outlet 4 and in which it has a cutting edge of the annular cutting element that is ready for cutting the material, and at least one post-cutting position, in which the cutting edge has already passed in front of the material outlet 4 and has already cut the material that has exited the material outlet 4 to separate the annular dose D.

The driving means of the separator 7 may be configured, in particular, to move the annular cutting element alternatively, in particular a reciprocating motion between the pre-cutting and post-cutting positions, to perform cutting cycles in order to form at least one annular dose D in each cycle.

This driving means may comprise, for example, cam means. This cam means may comprise, in particular, at least one (fixed) cam profile, for example a profile that substantially extends as an arc of circumference coaxial with an axis of rotation of the carousel. This cam means may comprise, in particular, at least one cam follower associated with the annular cutting element and coupled with the aforesaid cam profile. The cam follower may comprise, for example, (roller) rolling means that is slidable on the cam profile.

The application apparatus 1 may comprise, in particular, feeding means (which is not illustrated) configured to feed an object P. The feeding means may be configured, in particular, to feed a cap for closing containers so as to enable the annular dose D separated from the separator 7 to be deposited on the cap. The feeding means may be, in particular, feeding means of known type, like, for example, a caps conveying line comprising at least one conveying carousel.

The feeding means may comprise, in particular, at least one support for supporting the object P (in particular a support for supporting a cap for containers). The support may be movable with the possibility of adopting a receiving position (for example an upper position) in which the supported object P is near the material outlet 4 so that the annular dose D that has just been formed is in contact with a surface (base B) of the supported object P and can adhere to this surface. The support may be able to adopt a removal position (for example a lower position) in which the supported object P is far from the material outlet 4 so that the annular dose D that adheres more to the surface of the object P is detached from the separator 7.

The aforesaid surface of the object P may be activated beforehand (by heating and/or by a layer of primer and/or by other adhesion promoting means) to promote this detachment.

The material outlet 4 comprises at least one differentiated outlet part 8 arranged to generate a differentiated portion in the annular dose D, as will be explained better further on in the description. The term “portion” of the annular dose may mean, in particular, a zone arranged along the circumferential extent of the annular dose D. This zone (the length of which can be measured along the circumferential extent of the annular dose D) can be full of the material that forms the dose D, or partially empty of material, or completely empty of material.

The differentiated outlet part 8 is defined by the fact that a radial section considered in the differentiated outlet part 8 is different from a radial section considered in another part of the material outlet 4, where “radial” is understood to refer to an axis about which the material outlet 4 extends in a circumferential direction. In the specific embodiments illustrated here, the axis of the material outlet 4 coincides with the (vertical) axis of the feeder 2 and of the material feeding channel 3 and/or with the corresponding (vertical) movement axis between the feeder 2 and the separator 7.

The differentiated outlet part 8 may comprise, in particular, an outlet obstruction, which may be configured to form a local obstruction of the port along the circumferential extent of the material outlet 4 so as to prevent or limit the passage of the material, or an outlet enlargement, which may be configured so as to form a local widening of the port along the circumferential extent of the material outlet 4 so as to enable a greater quantity of material to pass through than to the surrounding port part.

The application apparatus 1 may comprise, in particular, two or more differentiated outlet parts 8 angularly spaced apart from each other and separated from each other by at least one continuous part of the material outlet 4.

The continuous part of material outlet 4 may be, in particular, a part of the material outlet 4 with a passage port of constant width. The width of the aforesaid passage port that is considered to be constant may be, in particular, the dimension parallel to the axis of the material outlet 4 or to the axis of the feeder 2. The aforesaid dimension of the passage port may be, in particular, a height (vertical dimension) of the passage port of the exiting material.

The application apparatus 1 may comprise, in particular, three, or four, or five, or six differentiated outlet parts 8 angularly spaced apart from each other and spaced by continuous parts of the material outlet 4.

Each continuous part of the material outlet 4 may be, in particular, a part of the material outlet 4 with a passage port of constant width.

The sum SD of the lengths in a circumferential direction of the differentiated outlet parts 8 may be, in particular, less than the sum SC of the lengths in the circumferential direction of the continuous parts of the material outlet 4. In particular, it is possible to provide for SD to be <0.75*SC, or SD<0.50*SC, or SD<0.25*SC, or SD<0.10*SC. In the specific embodiments illustrated, the material outlet 4 comprises four differentiated outlet parts 8 spaced apart angularly (in particular, equidistant) from one another and alternating with four continuous parts of the material outlet 4, wherein each continuous part of the material outlet 4 extends in length along the circumferential extent by an angle of about 80° and each differentiated outlet part 8 extends in length along the circumferential extent by an angle of about 10° (so that SD=0.125*SC).

Each differentiated outlet part 8 may extend, in particular, in a circumferential direction for a length less than one 1/10 (corresponding to an angular extent of less than 36°), or less than one 1/20 (corresponding to an angular extent less than 18°), or less than one 1/30 (corresponding to an angular extent less than 12°), or less than one 1/60 (corresponding to an angular extent less than 6°), of a total length of the material outlet 4 in the circumferential direction (i.e. of the circumference of extent of the material outlet 4, corresponding to an angular extent equal to 360°).

The application apparatus 1 may comprise, in particular, at least one cavity 9 obtained on the feeder 2 or on the separator 7 at the differentiated outlet part 8. This cavity 9 may be configured, in particular, so as to be filled by the exiting material exiting the feeding channel 3 inside the feeder 2. This cavity 9 may be shaped and arranged, in particular, so as to form, at a differentiated portion 10 of the annular dose D, a bridge 11 of material that joins two portions of the annular dose D that are contiguous with the differentiated portion 10 and situated on two opposite sides thereof.

In some embodiments the differentiated outlet part 8 may comprise, in particular, an outlet obstruction that is integral with the feeder 2 and the cavity 9 may comprise a cavity formed on the outlet obstruction, so that the cavity 9, receiving the plasticized material, enables the bridge 11 of material to be formed that joins the two portions of the annular dose that are contiguous with the differentiated portion 10.

In some embodiments, the differentiated outlet part 8 may comprise, in particular, an outlet obstruction that is integral with the feeder 2 and the cavity 9 may comprise a groove obtained on a circumference of the feeder 2 (for example a circumference that is contiguous with the outlet obstruction), so that also in these embodiments the cavity 9 enables the bridge 11 of material to be formed that joins the two portions of the annular dose that are contiguous with the differentiated portion 10.

In some embodiments, the differentiated outlet part 8 may comprise, in particular, an outlet enlargement. The cavity 9 may comprise, in particular, a slit formed on the separator 7, for example on the annular cutting element that cuts the annular dose D, so that the cavity 9 formed on the separator 7 enables an appendage 12 to be formed that protrudes from a closed annular body (in particular a body with a constant radial section along the entire circumference) of the dose D.

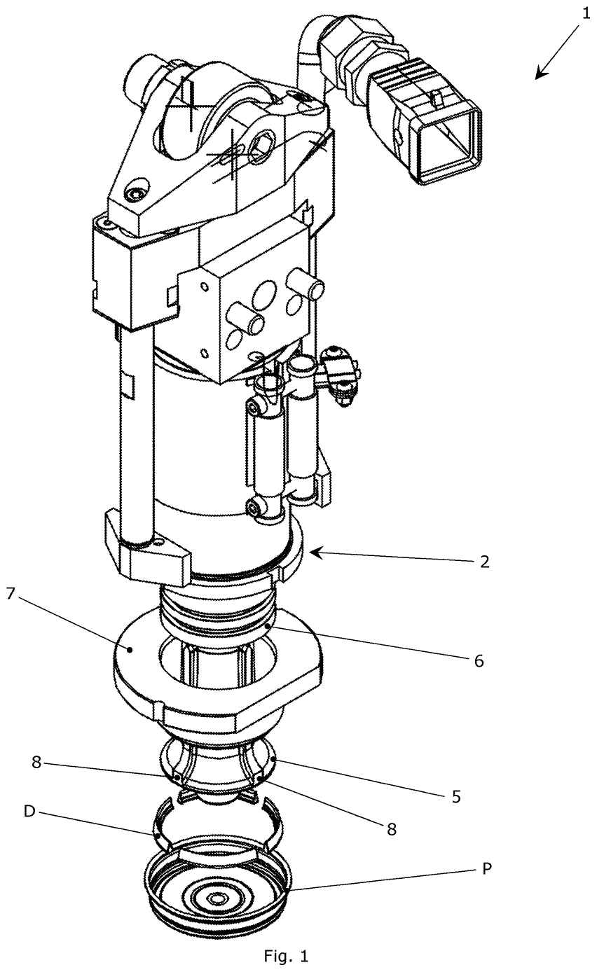

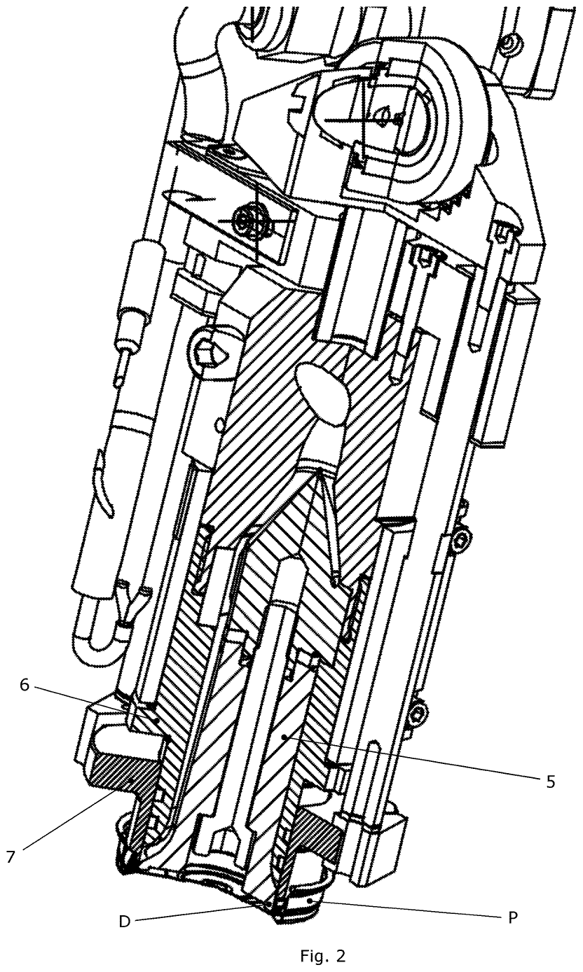

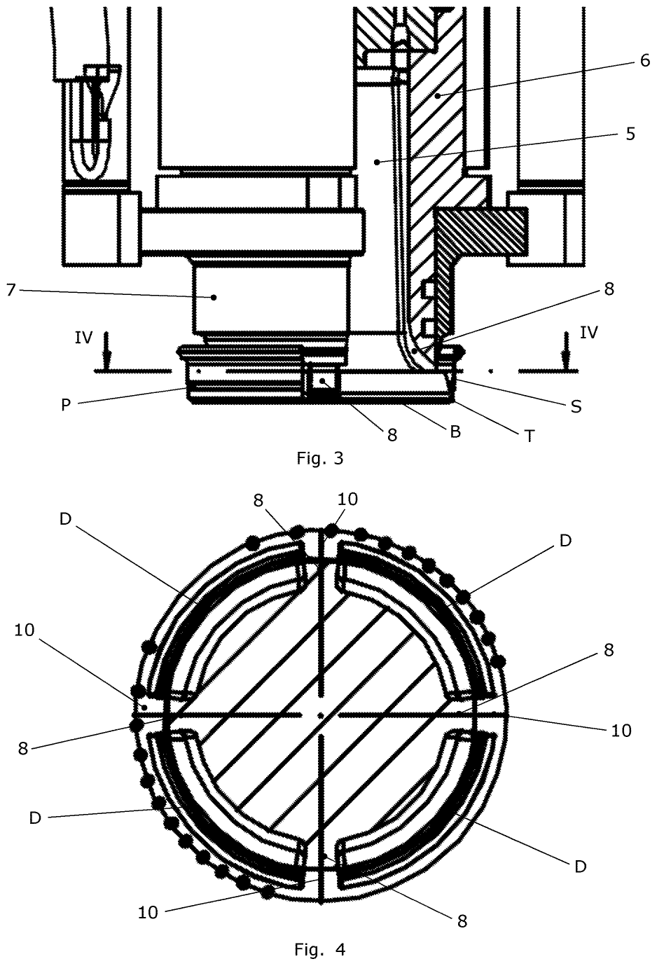

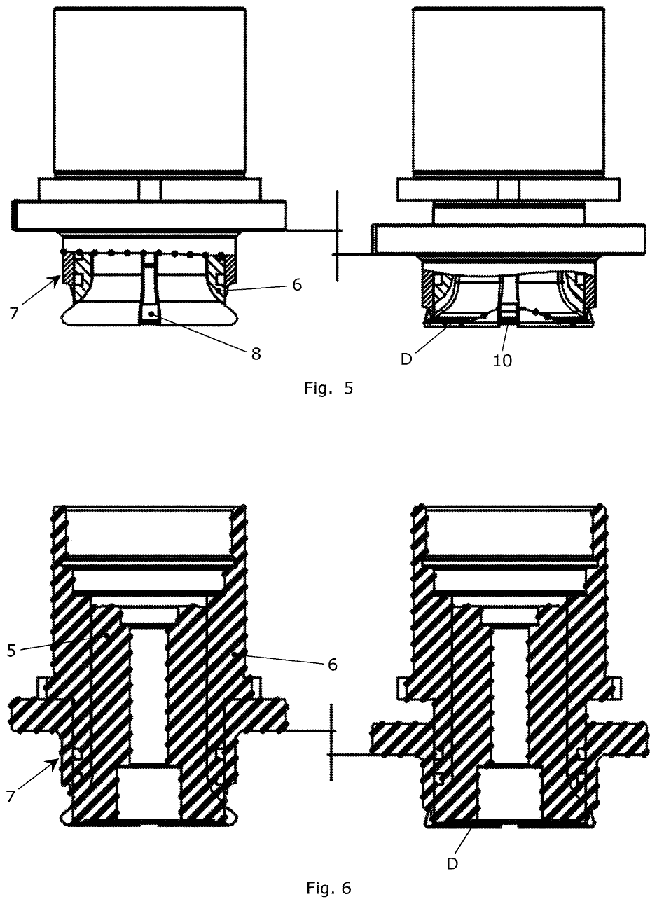

In the embodiment of FIGS. 1-6, the material outlet 4 has four differentiated outlet parts 8 formed by four obstructions arranged angularly spaced apart from each other and integral with the feeder 2 (in this embodiment, the obstructions are integral with the internal portion 5), alternating with four continuous parts of the material outlet 4 with a constant port width defined between the internal portion 5 and the external portion 6 of the feeder 2. Each obstruction may be made, in particular, by a rib that protrudes from the internal portion 5 and that extends inside the feeder 2. The separator 7 comprises an annular cutting element with a continuous circular cutting edge.

In operation, the sealing material will exit through the four continuous parts of the material outlet 4, whereas it will not be able to exit the four outlet obstructions. The separated annular dose D will then comprise four continuous portions of material, with constant radial section, each of which will extend in length along an arc of circumference (in the form of a circular sector arc), spaced apart by four differentiated portions 10, each of which will consist of an empty space, i.e. without sealing material, so that each continuous portion of material of the annular dose D will be separated from the other portion by a respective empty space.

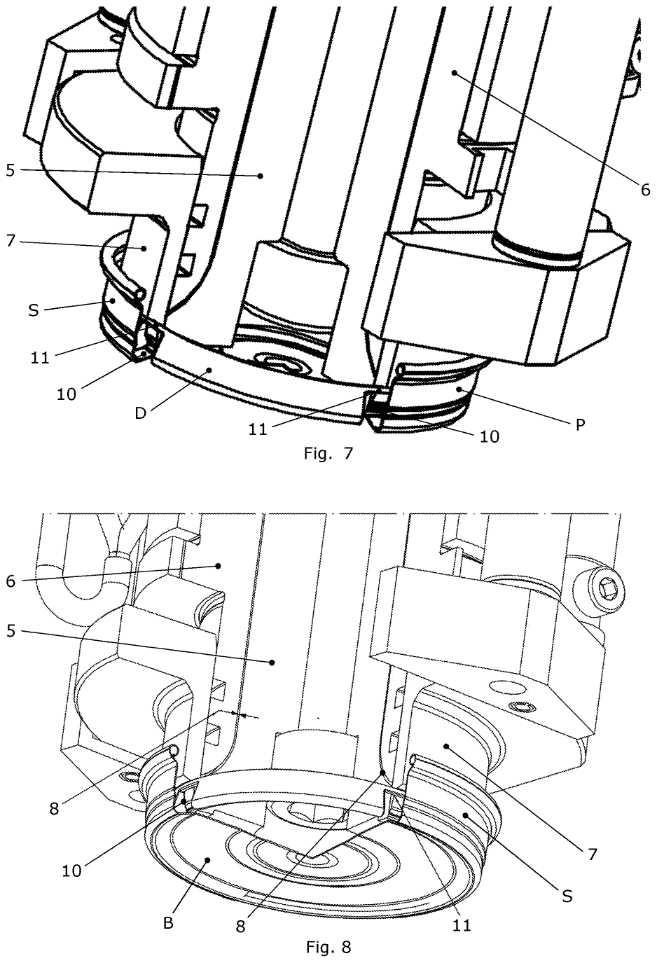

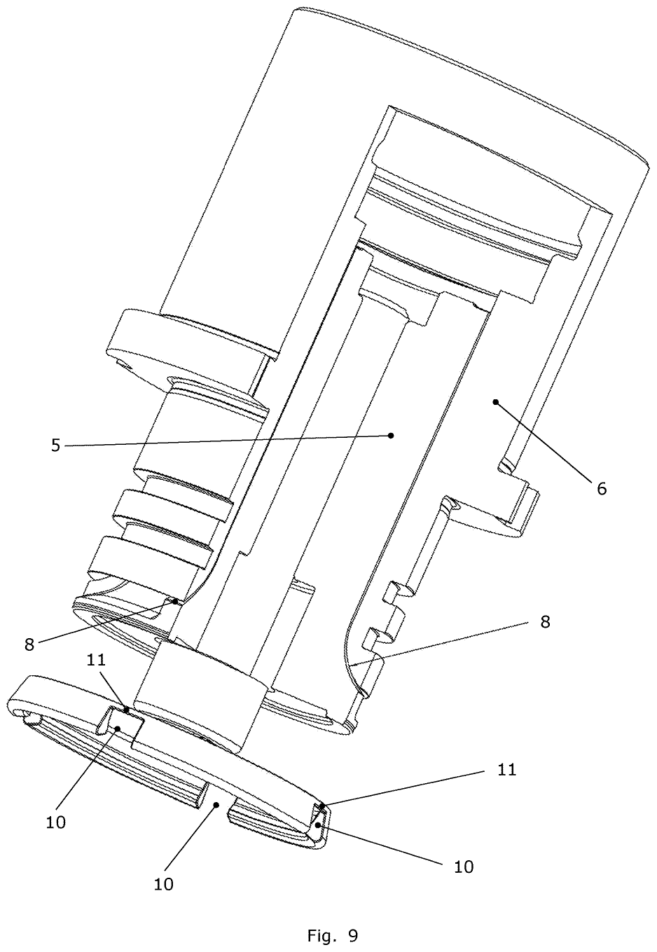

In the embodiment of FIGS. 7-9, the material outlet 4 has four differentiated outlet parts 8 arranged angularly spaced apart from each other, each of which comprises an obstruction that is integral with the feeder 2 (for example with the internal portion 5). In this embodiment, each obstruction has a dimension that is such as not to occupy all the space comprised between the two parts of the material outlet 4 arranged on opposite sides of the differentiated outlet part 8, because at each obstruction there is a cavity 9 in the shape of a cavity arranged between the internal portion 5 and the external portion 6 of the feeder 2. In this embodiment, each cavity 9 is arranged above the respective obstruction.

In operation, the sealing material will exit through the four continuous parts of the material outlet 4 and through the four openings (in this embodiment, relatively thin openings) defined by the four cavities 9 obtained as gaps between the internal portion 5 and the external portion 6, whereas it will not be able to exit at the four obstructions arranged below the four openings.

The separated annular dose D will then comprise four continuous portions of material, with constant radial section, each of which will extend in length along an arc of circumference, interspersed with four differentiated portions 10, each of which will comprise an empty space, i.e. without sealing material, and a bridge 11 of sealing material that will join the two continuous portions of material that are contiguous with the respective differentiated portion 10. In this embodiment, the bridges 11 of sealing material are arranged above, i.e. to join the upper portions of the various continuous portions of material.

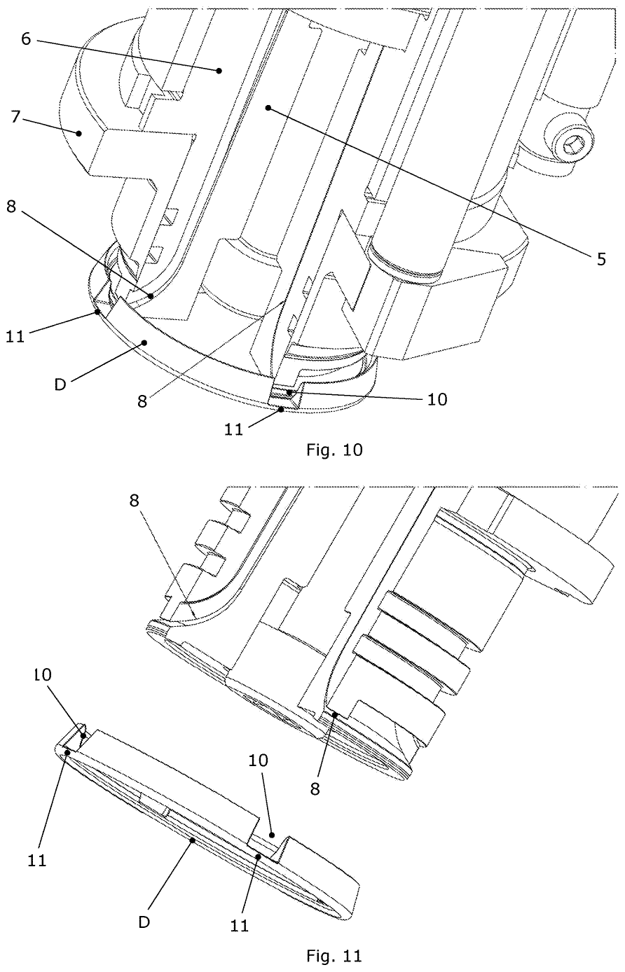

The embodiment of FIGS. 10-11 differs from that of FIGS. 7-9 through the fact that each cavity 9 is arranged below the respective obstruction, so that the separated annular dose D will comprise, also in this case, four continuous portions of material, with constant radial section, each extending along an arc of circumference, interspersed with four differentiated portions 10, each comprising a space without sealing material and a bridge 11 of sealing material to join two continuous portions of material, in which however the bridges 11 of sealing material are arranged below, i.e. to join the lower portions of the various continuous portions of material.

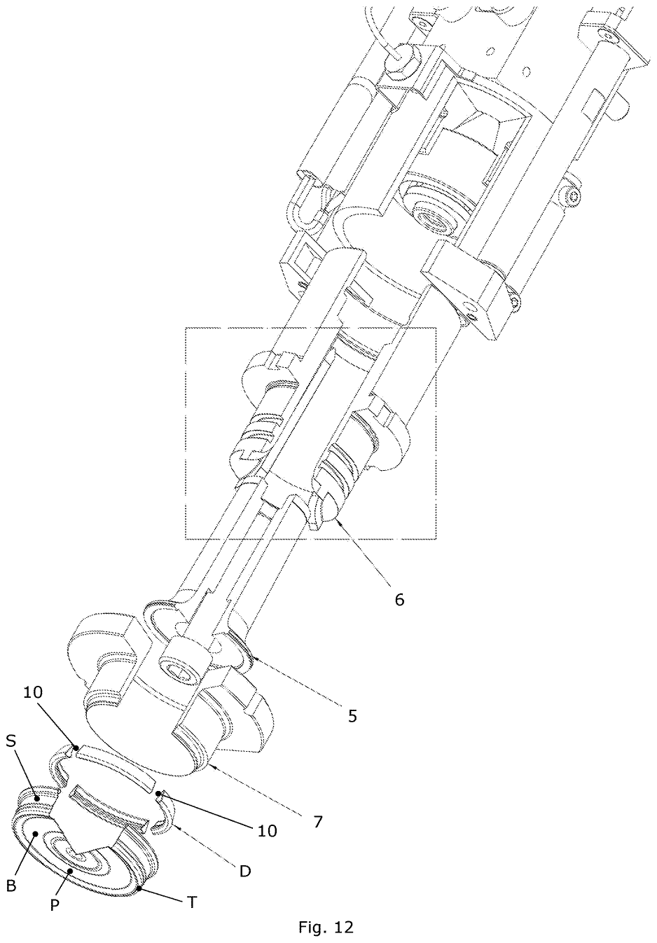

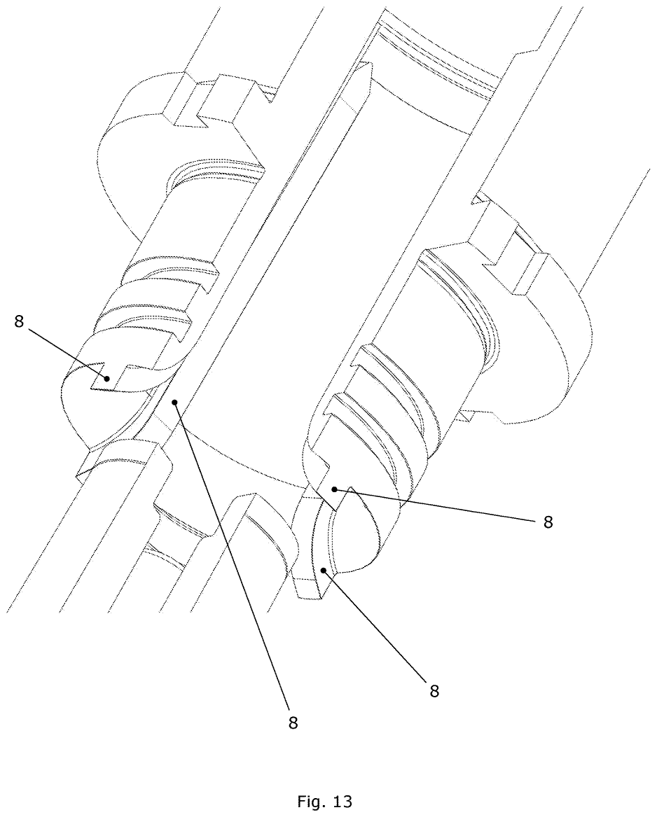

The embodiment of FIGS. 12-13 differs from that of FIGS. 1-6 through the fact that each differentiated outlet part 8 comprises an obstruction that is integral with the external portion 6, rather than the internal portion 5. The obstruction may be made from a rib that protrudes from the external portion 6. Also in this case, the separated annular dose D will comprise four continuous portions of material, with constant radial section, extending in length along circumference arcs, spaced apart by four differentiated portions 10 consisting of spaces free of sealing material that separate the various continuous portions of sealing material from one another.

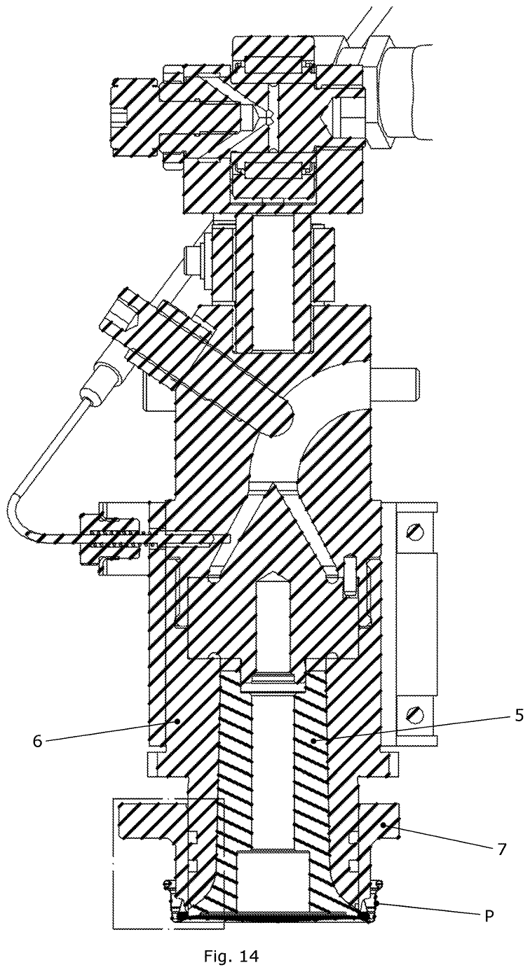

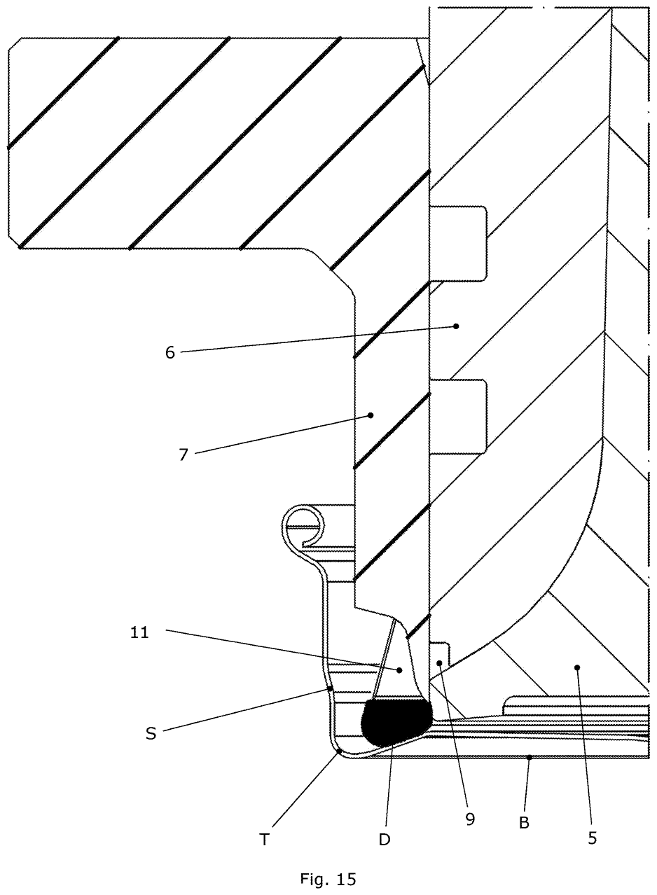

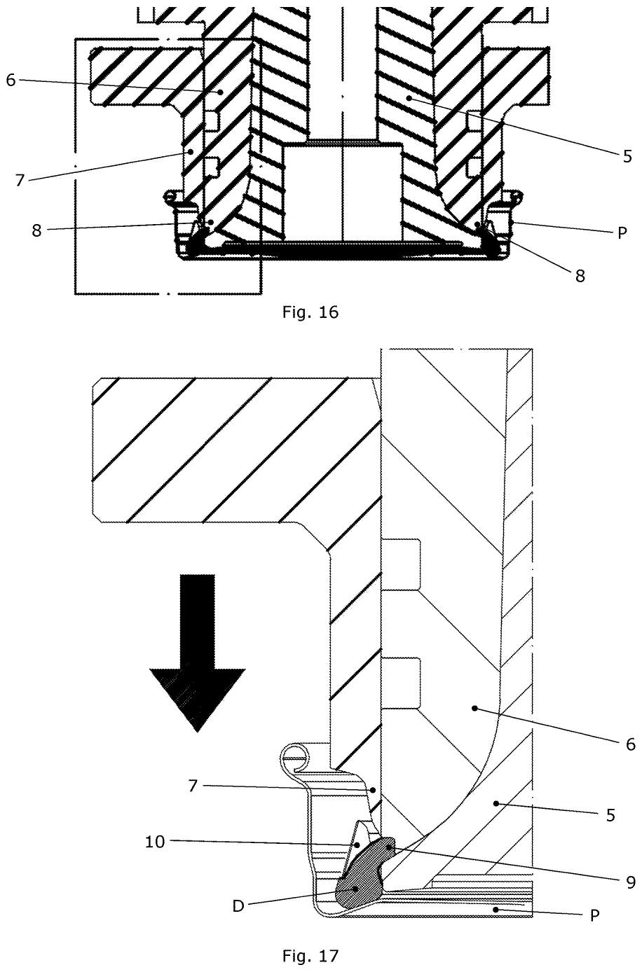

In the embodiment of FIGS. 14-17, the material outlet 4 has four differentiated outlet parts 8 arranged angularly spaced apart from each other. Each differentiated outlet part 8 comprises an obstruction that is integral with the feeder 2, in this case is integral with the external portion 6. The obstruction may be made from a rib that protrudes from the external portion 6.

Each differentiated outlet part 8 comprises a cavity 9 arranged at the respective obstruction. Each cavity 9 may be arranged, as in this embodiment, above the respective obstruction (rib). Each cavity 9 may comprise, as in this embodiment, a groove formed on the external portion 6 (in particular, on the obstruction that is integral with the external portion 6). Each cavity 9 may be obtained, in particular, by a machining task through removal of material of the external portion 6.

In operation, the sealing material will exit through the four continuous parts of the material outlet 4 and will further flow through the four cavities 9 obtained as grooves on the external portion 6 and will then exit through the four openings defined by the four cavities 9, whereas it will not be able to exit at the four obstructions arranged below the four cavities.

The annular dose D separated from the separator 7 will then comprise four continuous portions of material, with constant radial section, each of which will extend in length along an arc of circumference, spaced apart by four differentiated portions 10, each of which will comprise an empty space, i.e. without sealing material, and a bridge 11 of sealing material that will join the two continuous portions of material that are contiguous with the respective differentiated portion 10. In this embodiment, the bridges 11 of sealing material are arranged above, i.e. to join the upper portions of the various continuous portions of material.

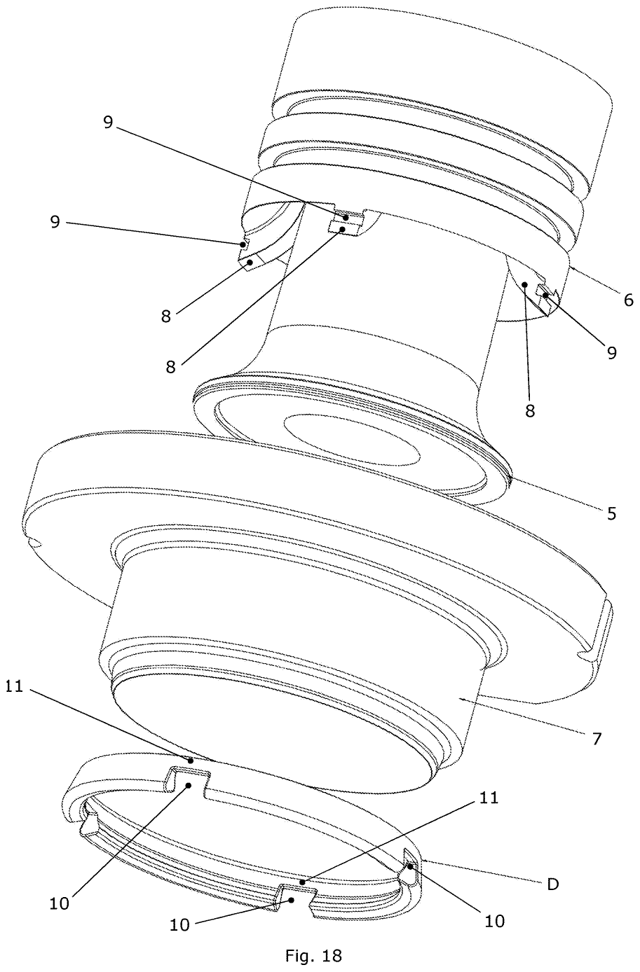

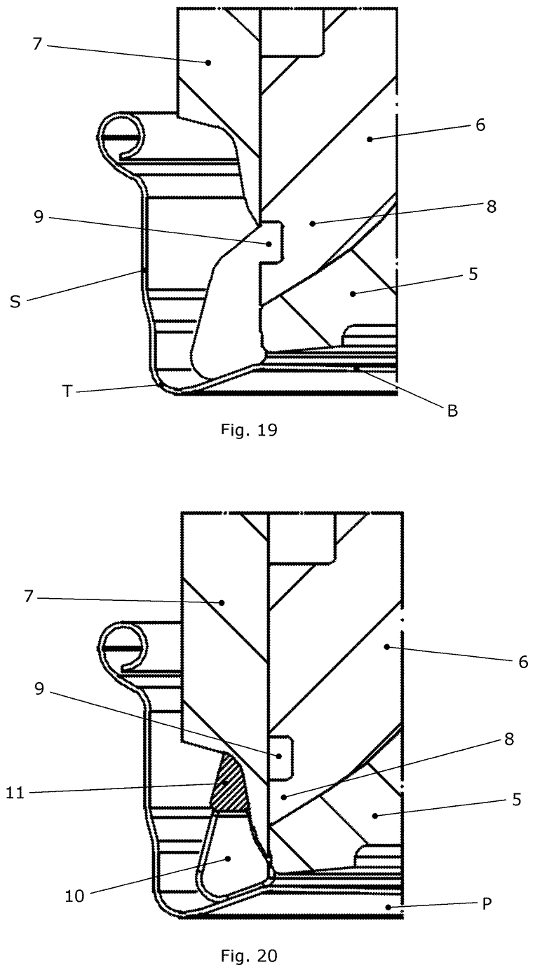

The embodiment of FIGS. 18-20 is similar to that of FIGS. 14-17, with four cavities 9 obtained as grooves on the external portion 6. In this embodiment the grooves are arranged differently from the preceding embodiment. In particular, in this embodiment the cavities 9 (grooves) are arranged on the external portion 6 at a distance from the internal portion 5, whereas in the preceding embodiment they were arranged contiguously with the internal portion 5. The annular dose D that is separated is also formed in this case from four bridges 11 with a radial section lower than the radial section of the four dose parts that are joined by the bridges.

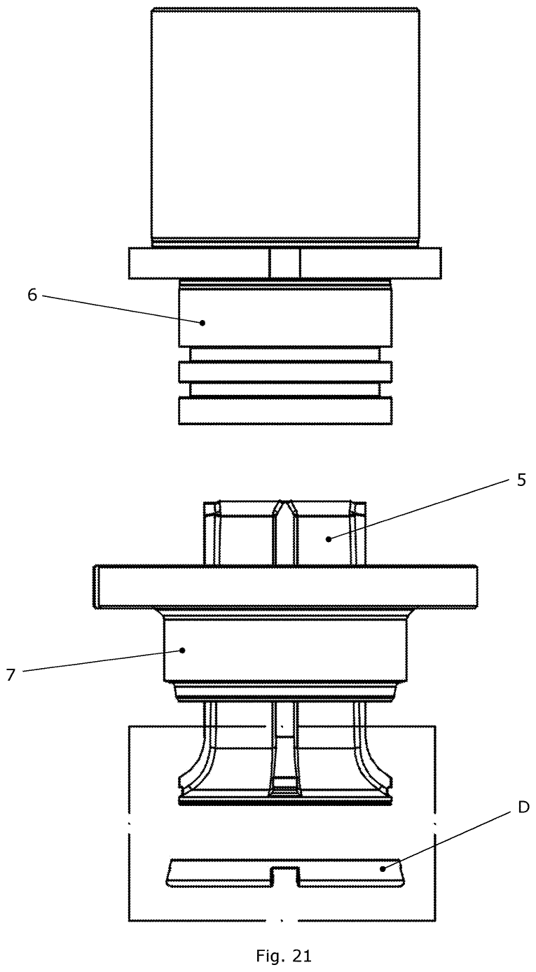

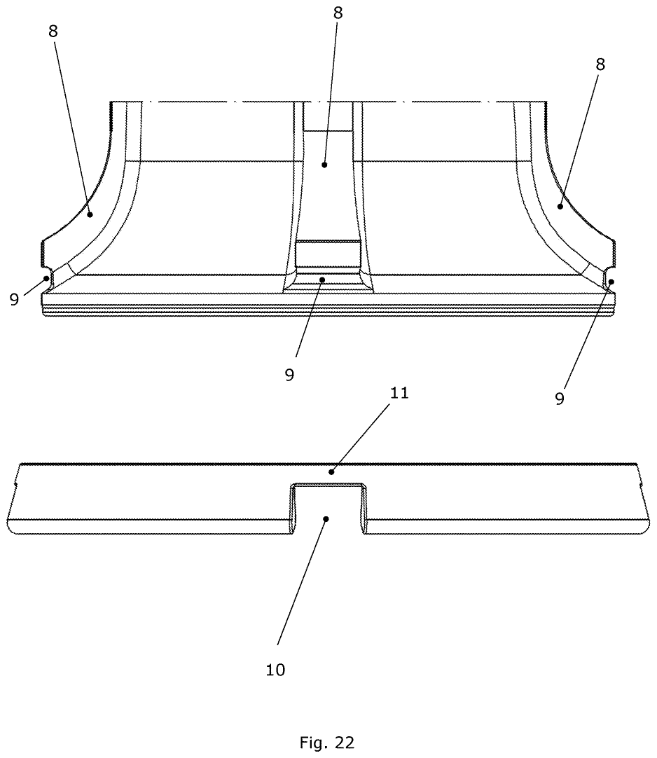

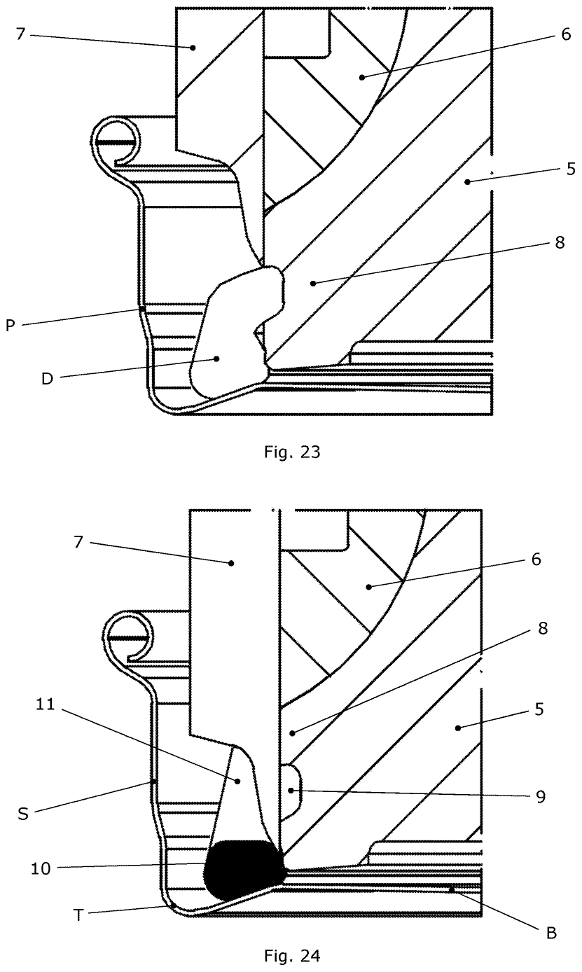

The embodiment of FIGS. 21-24 differs from that of FIGS. 18-20 through the fact that the cavities 9 are obtained as grooves formed on the obstructions (ribs) that are integral with the internal portion 5, rather than as grooves formed on the obstructions (ribs) that are integral with the external portion 6. Also in this embodiment, the separated annular dose D comprises four bridges 11 arranged above.

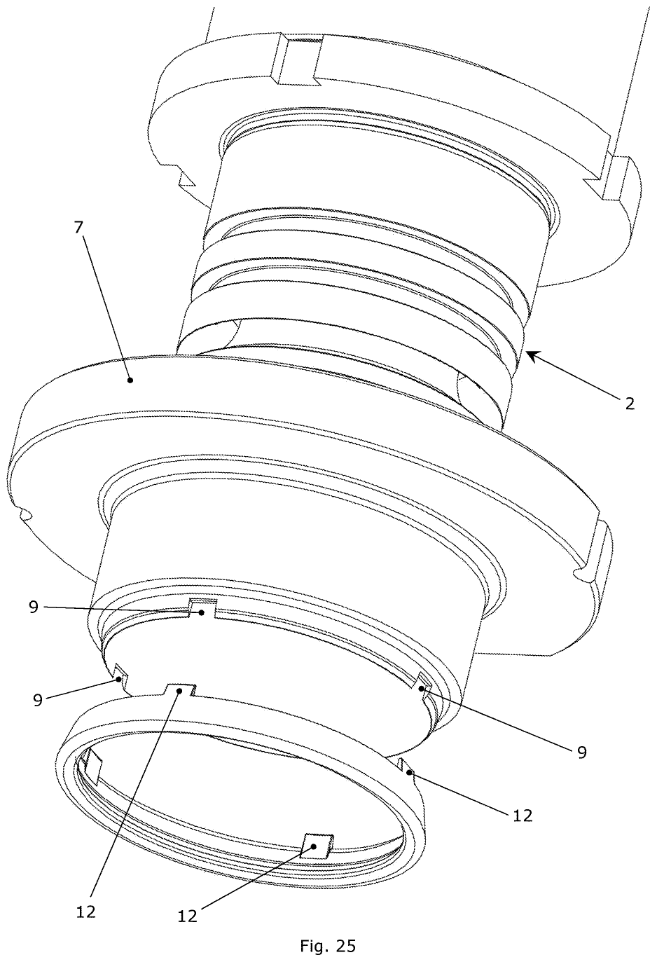

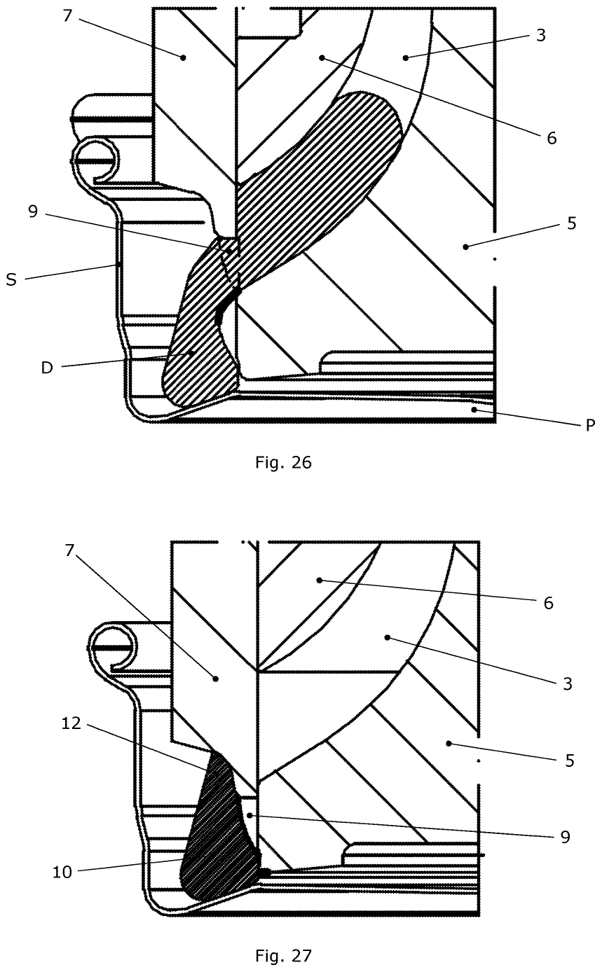

In the embodiment of FIGS. 25-27, the material outlet 4 has four differentiated outlet parts 8 that are formed by four cavities 9 arranged angularly spaced apart from each other, each of which is obtained as a slit on a cutting edge of the separator 7, in particular on the annular cutting edge of the annular cutting element that separates the dose D from the rest of the plasticized sealing material.

In this case, the cavities 9 are arranged on the separator 7, whereas the material outlet 4 arranged on the feeder 2 has a circumferential extent that is continuous with a passage port (height) that is constant over the entire circumference. The cavities 9 (slits) on the separator 7 actually constitute the same number of differentiated outlet parts 8 that give rise to outlet enlargements in the step of separating the annular dose D.

In practice, in this embodiment each differentiated outlet part 8 is made indirectly, by an interruption arranged on the separator 7, rather than by an interruption arranged directly on the material outlet 4 of the channel 3 inside the feeder 2, as in the preceding embodiments.

In operation, the sealing material will exit through the material outlet 4, formed in this case by an outlet with a constant passage port over the entire circumferential extent of the material outlet 4, whereas the differentiated portions 10 of the dose D are formed through the effect of the interruptions formed on the separator 7 and defined by the cavities 9 (in the form of slits on the annular cutting element).

The various cavities (slits) cause a certain delay in the actual momentum of the cutting of the material, with respect to the rest of the cutting edge of the separator 7, causing greater local dispensing of exiting material from the channel 3 at the very cavities 9 and thus giving rise to the formation of the differentiated portions 10 that comprise, in this case, the appendages 12.

It is possible to provide a (non-illustrative) embodiment that differs from that of FIGS. 25-27 through the fact that the separator 7 comprises, instead of the cavity 9 in the form of slits on the annular cutting element, teeth that protrude from the annular cutting element and cause a certain anticipation of the actual momentum of the cutting of the material, with respect to the rest of the cutting edge of the separator 7, causing a local anticipated interruption of the dispensing of the plasticized exiting material from the channel 3 at the very teeth and thus giving rise to the formation of differentiated portions consisting, in this case, of portions with less material and thus with a radial section that is lower than the radial section of the adjacent portions.

In the embodiments disclosed here, the material outlet 4 has four differentiated outlet parts 8 (in particular, parts arranged angularly equidistant from one another) to form the same number of differentiated portions 10 of the annular dose D. It is possible to provide embodiments in which the material outlet 4 has a different number N (for example, three or five or six, or 2≤N≤15, in particular 3≤N≤9) of differentiated outlet parts 8 to form the same number of differentiated portions 10 of the annular dose D.

The operation of the application apparatus may actuate, in particular, an application method that comprises the step of feeding plasticized material, in particular sealing material suitable for forming a gasket, through at least one channel 3 formed in a feeder 2 as far as at least one material outlet 4 extending along a circumferential direction about an axis of the feeder 2.

The application method comprises the step of separating an annular dose D of material from the material outlet 4 by a separator 7 which surrounds the feeder 2 and in which the separator 7 and the feeder 2 are moved coaxially to one another. The shear rate measured on the wall (commonly known as shear rate y) with which the plastics flow in the channel 3 may be chosen, in particular, in a range 2≤γ≤150 sec⁻¹, more in particular 4≤γ≤80 sec⁻¹.

The application method comprises the step of depositing the annular dose D on an object P, in particular on a base B of an object P, in which the object P may be, for example, a cap for closing containers.

The separated annular dose D comprises at least one differentiated portion 10, where “differentiated portion” means a portion, arranged along the circumferential extent of the annular dose D, at which a radial section of the annular dose D is different from a radial section considered in another portion of the annular dose D.

The term “radial” refers in this description to an axis about which the annular dose D extends in a circumferential direction. This axis may coincide, in particular, with the (vertical) axis of the feeder 2.

The separated annular dose D may comprise, in particular, two or more differentiated portions 10 (in particular, four or five differentiated portions 10, although it is possible to provide a different number N, for example three, or six, or seven or more than seven differentiated portions 10, or a number N of differentiated portions 10 with 2≤N≤15, in particular 3≤N≤9) spaced angularly apart (in particular, equidistant) from one another and separated from one another by at least one continuous portion of material that forms the annular dose D (in particular, continuous portions interspersed with differentiated portions 10).

Each continuous portion may comprise, in particular, a portion of material with a constant radial section. Each continuous portion may comprise, in particular, a portion of material extending in length and shaped as an arc with a circular sector. The continuous portions may be, in particular, shaped as arcs with a circular sector of the same length. The differentiated portions 10 may in particular extend longitudinally by the same circumferential length.

The sum SD of the lengths in the circumferential direction of the differentiated portions 10 may be, in particular, less than half the sum SC of the lengths in the circumferential direction of the continuous portions (in the form of circular sector arcs). In particular, 0.25*SC may be <SD<0.05*SC. Each differentiated portion 10 may, in particular, extend in the circumferential direction for a length less than one 1/10 , or less than one 1/20 , or less than one 1/30 , or less than one 1/60 , of a length of the annular dose in the circumferential direction.

Each differentiated portion 10 may consist, in particular, of a cavity that is not occupied by the material. Each differentiated portion 10 may include, in particular, a cavity that is not occupied by the material. A radial section in the differentiated portion 10 may be, in particular, completely free of sealing material or have less material than a radial section in another portion of the annular dose D.

Each cavity in a differentiated portion 10 may be, in particular, bounded between two end surfaces which face each other in a circumferential direction and are arranged on two respective portions of the annular dose D. The two aforesaid respective portions of the annular dose D may be, in particular, two portions extending in length along an axis shaped like a circumference arc, i.e. two portions or segments of material in the form of a circular sector arc.

Each differentiated portion 10 may comprise, in particular, at least one bridge 11 of material that joins two portions of the annular dose D, in particular two portions each extending in length with a constant radial section.

The cutting frequency of the separator 7 may be chosen according to the quantity of material that will have to form the annular dose D. This quantity may depend, in particular, on the dimensions of the object P and/or on the dimensions of the gasket G obtained from moulding the dose D. It is possible to provide, for example, for forming an annular gasket on a cap of the “press on/twist off” with a nominal diameter of 51 millimeters, an annular dose D divided into four dose parts in the form of a circular crown arc separated by differentiated portions of dose without material, in which each dose part in the form of a circular crown arc weighs 0.25 grams, or 0.4 grams, or a weight value comprised between 0.25 and 0.4 grams, or divided into five dose parts each with a weight equal to 0.3 grams, or 0.35 grams, or a weight comprised between 0.30 and 0.35 grams. According to another embodiment, for forming an annular gasket on a cap of the “press on/twist off” type with a nominal diameter of 48 millimeters, an annular dose D may be divided into three dose parts in the shape of a circular crown arc separated by differentiated portions of dose without material, in which each dose part in the form of a circular crown arc weighs 0.25 grams, or may be divided into four dose parts each with a weight value equal to 0.3 grams, or divided into five dose parts in the shape of a circular crown arc separated by differentiated portions of dose without material, wherein each dose part in the form of a circular crown arc weighs 0.25 grams. As seen from these embodiments, the annular dose D may have a different overall weight according to the particular case. It is possible, for each particular case, to have a different number of dose parts, for example by leaving the overall weight of the annular dose D almost constant.

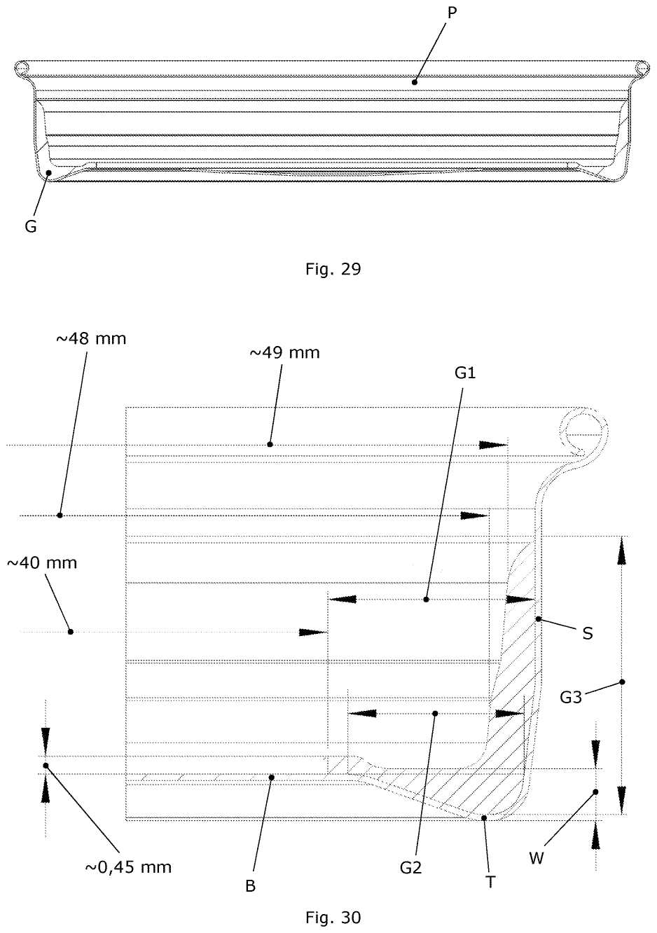

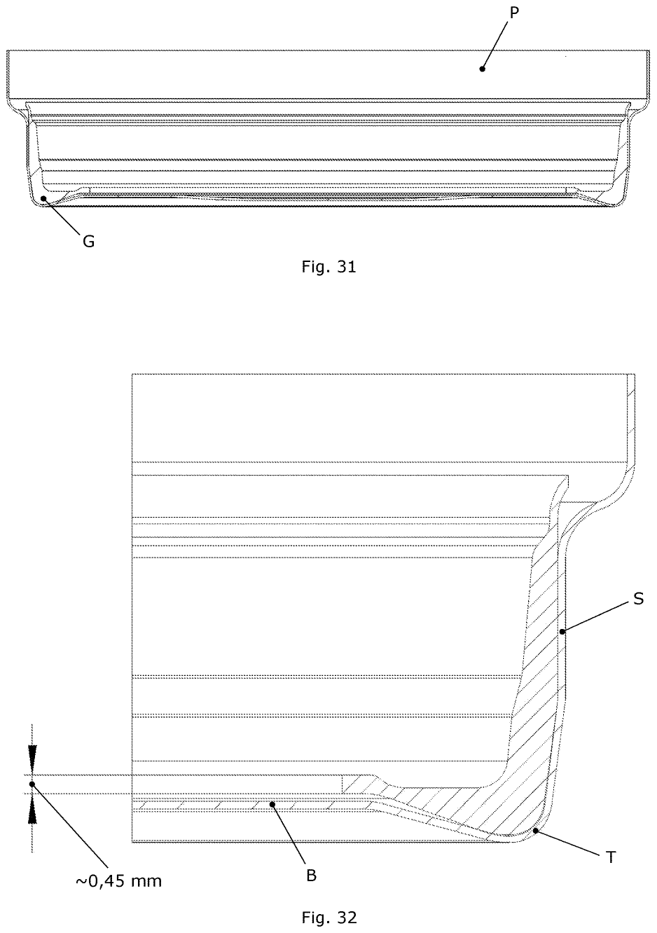

The annular dose D is separated from the material outlet 4 by the separator 7 and deposited on the object P. It is possible to provide a step, which is not illustrated, in which the annular dose D deposited on the object P is pressed (for example by an annular compression-moulding punch) to form a gasket. In FIG. 29, an object P is shown (in particular, a closing cap) with an annular gasket G obtained by compression moulding of an annular dose D. In FIG. 30, a maximum radial dimension of the annular gasket G measured from a more internal edge to a more external edge of the gasket has been indicated by G1, with 2 a maximum radial dimension annular recess present at the transition zone T of the object P (cap) where the risk of formation of an undesired air pocket between the gasket G and the object P is greater, G3 being a maximum height of the gasket G, W being a thickness of the cap that includes both a thickness of the gasket G (thickness taken at the outer seal surface of the gasket G that has been pressed further down in the moulding step) and a thickness of the sheet-metal body of the cap.

The aforesaid thickness W may be, in particular, comprised between 0.3 mm and 2 mm, more in particular between 0.55 mm and 1.6 mm, still more in particular between 0.8 mm and 1.3 mm. Further, in FIG. 30 some dimensions (diameters or thicknesses), of an annular gasket G have been indicated merely by way of example.

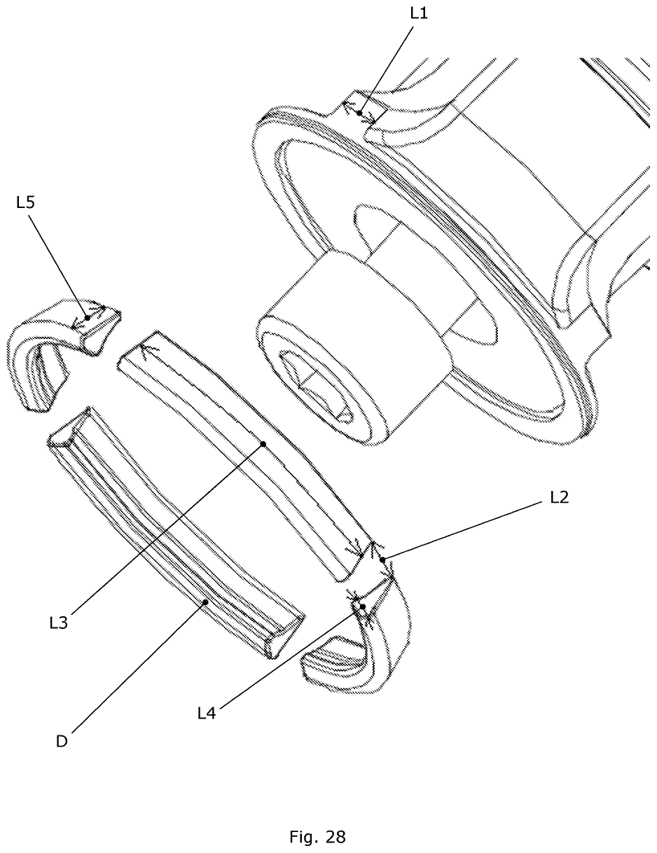

With reference to FIG. 28, a length, or maximum circumferential extent of a differentiated outlet part 8 (in particular, an outlet obstruction) has been indicated by L1, a length, or maximum circumferential extent of a differential portion 10 of the dose D (in particular, an empty portion completely free of material) with L2, a length, or maximum circumferential extent of a continuous portion (in particular, with a constant full radial section) of the dose D comprised between two differential portions 10 with L3, a maximum width or maximum radial extent, of the full radial section of the continuous portion of the dose D with L4, a height, or maximum axial extent, of the full radial section of the continuous portion of the dose D with L5.

It has generally been found that L1˜L2, although in some cases it is possible to ascertain L1<L1 or L1>L2 depending on the process conditions and the rheological properties of the material.

It is in particular possible for the L3/L2 relation between the length L3 of a continuous portion of the separated annular dose D and the length L2 of a differential portion 10 of the separated annular dose D to be comprised between 2 and 20 (20≥L3/L2 ≥2), more in particular comprised between 2.5 and 12 (12≥L3/L2≥2.5), by an appropriate adjustment of the process of applying the dose D and/or an appropriate sizing of the application apparatus 1. Choosing this relation L3 /L2 enables the evacuation of air to be promoted and the risk of formation or air bubbles or air pockets between the gasket G and the object P to be reduced.

It is possible to provide (by an appropriate adjustment of the process of applying the dose D and/or an appropriate sizing of the application apparatus 1) for, in particular, the width L4 of a continuous portion of the separated annular dose D being greater than or the same as the height L5 of the continuous portion of dose, if the maximum radial dimension G1 of the annular gasket-that has to be molded from the annular dose D—is greater than the maximum height G3 of the gasket (i.e. L4≥L5 if G1≥G3), whereas, in particular, L4 will be ≤L5 if G1≤G3. This choice of relation L4/L5 enables the evacuation of air to be promoted and the risk of formation of air bubbles or pockets between the gasket G and the object P to be reduced.

It is possible to provide (by an appropriate adjustment of the process of applying the dose D and/or an appropriate sizing of the application apparatus 1) for the width L4 of a continuous portion of the separated annular dose D being, in particular, about the same as the maximum radial dimension G2 of the annular recess present at the transition zone T (i.e. L4˜G2). It is in particular possible for G2 to be little greater than L4, for example no greater than 10% of L4, i.e. L4<G2≤1.1* L4.

In general, the provision of one or more differentiated portions 10 reduces the risk of the formation of air pockets between the sealing material and the object P on which the annular dose D has been deposited and possibly pressed.

The annular dose D may be deposited, in particular, inside an annular wall S of the object P connected to a base B of the object P by a transition zone T. The objects P may comprise, in particular, caps (for example, caps made of plastic, or crown caps, or caps made of metal, or still other types of cap) each provided with a seal device, like for example a liner or gasket. The seal device is made with the aforesaid sealing material and may be molded from a single type of plastics or may be made from a compounds of different plastics or may have a multilayered structure.

The annular dose D may form a polymer gasket made, in particular, of low-density polyethylene (LDPE), or of linear low-density polyethylene (LLDPE), or of ultra linear low-density polyethylene (ULDPE), or of mixtures of similar products, or of ethylene vinyl acetate (EVA), or of a polyvinyl chloride (PVC)-based compound.

Alternatively, in order to make the annular dose D, it is possible to use sealing material comprising thermoplastic elastomers and compounds thereof, for example combinations of polyolefins and styrenic block copolymers, combinations of hard polymers and elastomers like, for example, polypropylene and ethylene-propylene PP/EPR or polypropylene and ethylene propylene diene monomer PP/EPDM.

The density of the sealing material (polymer or mixtures) used, in particular, to form the gasket, may be comprised between 0.87 and 0.94 g/cm³, in particular between 0.88 and 0.92 g/cm³. The hardness of the sealing material (polymer or mixtures) used, in particular, to form the gasket may be comprised between 40 and 90 Shore A, in particular between 55 and 85 Shore A.

1. Application method, comprising the steps of:
feeding material through at least one channel formed in a feeder up to at least one material outlet extending along a circumferential direction around an axis of the feeder
separating an annular dose of material from the material outlet by means of a separator which surrounds the feeder and wherein the separator and the feeder are moved coaxially relative to each other;
depositing the annular dose on an object;
wherein the separated annular dose comprises one or more differentiated portions in which a radial section in a differentiated portion of the annular dose is different from a radial section in another portion of the annular dose, where “radial” is understood to refer to an axis about which the annular dose extends in a circumferential direction.

2. Method according to claim 1, wherein the separated annular dose comprises two or more differentiated portions angularly spaced apart from each other and separated from each other by at least one continuous portion of material of the annular dose, in particular a number N of differentiated portions (10) with 2≤N≤15, more in particular 3≤N≤9.

3. Method according to claim 2, wherein each continuous portion of material is shaped like a circular sector arc with an angular extent greater than 30°, or greater than 45°, or greater than 60°; each continuous portion of material having, in particular, a constant radial section.

4. Method according to claim 19, wherein the sum SD of the lengths in the circumferential direction of the differentiated portions is less than the sum SC of the lengths in the circumferential direction of the continuous portions; in particular, SD<0.75*SC, or SD<0.50*SC, or SD<0.25*SC, or SD<0.10*SC. CM 5. Method according to claim 1, wherein each differentiated portion extends in the circumferential direction for a length of less than one 1/10, or less than one 1/20, or less than one 1/30, or less than one 1/60, of a length of the annular dose (D) in the circumferential direction. CM 6. Method according to claim 1, wherein each differentiated portion consists of, or includes, a cavity unoccupied by the material, whereby a radial section in the differentiated portion is free of material or has less material than a radial section in another portion of the annular dose. CM 7. Method according to claim 6, wherein each cavity is bounded by two end surfaces which face each other in a circumferential direction and are arranged on two respective portions of the annular dose; the two respective portions of the annular dose being, two portions extending in length along an axis shaped like a circumference arc. CM 8. Method according to claim 7, wherein each differentiated portion comprises at least one bridge of material that joins the two portions of the annular dose situated on opposite sides of the differentiated portion. CM 9. Method according to claim 1, wherein the annular dose is deposited inside an annular wall of the object connected to a base of the object by a transition zone. CM 10. Application apparatus, comprising:
a feeder in which at least one channel is obtained for feeding material up to at least one material outlet extending along a circumferential direction about an axis of the feeder;
a separator which surrounds the feeder and which is configured to separate an annular dose of material from the material outlet, the separator and the feeder being movable coaxially to one another, the annular dose being intended to be deposited on an object in order to form a gasket;
wherein the material outlet comprises at least one differentiated outlet part arranged to generate a differentiated portion in the annular dose, in which a radial section in a differentiated outlet part is different from a radial section in another part of the material outlet, where “radial” is understood to refer to an axis about which the material outlet extends in a circumferential direction.

11. Apparatus according to claim 10, comprising two or more differentiated outlet parts angularly spaced apart from each other and separated from each other by at least one continuous part of the material outlet; said apparatus comprising a number N of differentiated outlet parts (8) with 2≤N≤15, more in particular 3≤N≤9.

12. Apparatus according to claim 22, wherein each continuous part of the material outlet extends along an arc of circumference with an angular extent greater than 30°, or greater than 45°, or greater than 60°; the sum SD of the lengths in a circumferential direction of the differentiated outlet parts of the material outlet being less than the sum SC of the lengths in the circumferential direction of the continuous parts of the material outlet; in particular, SD<0.75*SC, or SD<0.50*SC, or SD<0.25*SC, or SD<0.10*SC.

13. (canceled)

14. Apparatus according to claim 10, wherein each differentiated outlet part of the material outlet (4) extends in a circumferential direction for a length less than one 1/10, or less than one 1/20, or less than one 1/30, or less than one 1/60, of a total length of the material outlet in the circumferential direction.

15. Apparatus according to claim 10, wherein the differentiated outlet part comprises at least one cavity obtained on the to form, in the differentiated portion of the annular dose, a bridge of material that joins two portions of the annular dose, and wherein the differentiated outlet part comprises an outlet obstruction that is integral with the feeder and the cavity comprises a gap formed in the feeder or a groove obtained on the outlet obstruction.

16. (canceled)

17. Apparatus according to claim 10, wherein the differentiated outlet part comprises at least one cavity in the form of a slit obtained on an annular cutting element of the separator to form an appendage of material that protrudes from the annular dose.

18. Method according to claim 1, wherein the material comprises sealing material suitable for forming a gasket and the object comprises a base of a cap for closing containers.

19. Method according to claim 1, wherein the separated annular dose comprises three, or four, or five, or six differentiated portions angularly spaced apart from each other and interspersed with continuous portions of material of the annular dose.

20. Apparatus according to claim 10, wherein the feeder is connected to an extruder for sealing material that is suitable for forming a gasket and the material includes plasticized material; said object being a cap for closing containers.

21. Apparatus according to claim 10, wherein the differentiated outlet part comprises an outlet obstruction or an outlet enlargement.

22. Apparatus according to claim 11, comprising three, or four, or five, or six differentiated outlet parts angularly spaced apart from each other and separated from each other by continuous parts of the material outlet; each continuous part of the material outlet having a constant passage port.
